(19) United States
(12) Patent Application Publication
(10) Pub. No.: US 2018/0329646 A1
(43) Pub. Date: Nov. 15, 2018

(54) DISTRIBUTED STORAGE SYSTEM VIRTUAL AND STORAGE DATA MIGRATION

(71) Applicant: International Business Machines Corporation, Armonk, NY (US)

(72) Inventors: Qiu Ping Dai, Shanghai (CN); Fei Li, Beijing (CN); Xiao Bing Liu, Beijing (CN); Jian Dong Yin, Beijing (CN)

(21) Appl. No.: 15/593,585

(22) Filed: May 12, 2017

(51) Int. Cl. G06F 3/06

(52) U.S. Cl. CPC G06F 3/0647; G06F 3/067; G06F 3/0604

(57) ABSTRACT

A request is received to migrate a virtual instance from a source host compute node. The source host compute node is included in a distributed storage system environment. The virtual instance is migrated from the source host compute node to a first target host compute node. The first target host compute node has access to a first storage device. The first storage device includes one or more data units associated with the virtual instance. As part of the request to migrate the virtual instance, the one or more data units are migrated to a second storage device associated with the first target host compute node.

### BACKGROUND

This disclosure relates generally to distributed storage systems, and more specifically, to migrating storage data between storage devices for local I/O access.

Advances in computing technology have allowed multiple machines to be aggregated into computing clusters of immense processing power and storage capacity that can be used to solve much larger problems than could a single machine. Clustering allows for the distribution and partitioning of workloads or programs to one or more host compute nodes. But it may be difficult for these partitioned programs to cooperate or share resources. Perhaps the most important such resource for maintaining cluster efficiency is the distributed storage system. In the absence of certain distributed storage systems, individual components of a partitioned program may have to share cluster storage in an ad-hoc manner. This typically complicates programming, limits performance, and compromises reliability.

### SUMMARY

One or more embodiments are directed to a computer-implemented method, a system and a computer program product. A request to migrate a virtual instance from a source host compute node may be received. The source host compute node may be included in a distributed storage system environment. A target host compute node may be selected to migrate the virtual instance to. The target host compute node may have access to a first storage device. The first storage device may include one or more data units associated with the virtual instance. The virtual instance may be migrated from the source host compute node to the target host compute node. The one or more data units may be migrated in parallel with the migrating of the virtual instance to a second storage device associated with the target host compute node.

### BRIEF DESCRIPTION OF THE DRAWINGS

FIG. 1 is a block diagram of an example network architecture, according to embodiments.

FIG. 2 is a block diagram of an example network architecture, according to embodiments.

FIG. 3 is a block diagram of an example computing environment, according to embodiments.

FIG. 4 is a flow diagram of an example process of selecting a target host compute node for storage data unit migration, according to embodiments.

FIG. 5 is a flow diagram of an example process for data block migration between storage devices, according to embodiments.

FIG. 6 is a flow diagram of an example process for data migration, according to embodiments.

FIG. 7 is a flow diagram of an example process for migrating block data in parallel with virtual instance data, according to embodiments.

FIG. 8 depicts a cloud computing environment, according to embodiments.

FIG. 9 depicts abstraction model layers, according to embodiments.

FIG. 10 is a block diagram of a computing device, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to migrating storage data between storage devices for local I/O access in distributed storage system environments. As disclosed herein, a “distributed storage system” can include multiple computing devices that each include or are associated with their own storage device(s) of data. Instead of a single centralized data repository storage device, there may be multiple storage devices. In some embodiments, these multiple computing devices are connected via a network and share storage device resources. A distributed storage system, for example, may be or include a cluster file system, a shared-disk file system, a shared-nothing file system, a parallel file system, a global file system, a symmetric file system, and an asymmetric file system. While the present disclosure is not necessarily limited to such applications, various aspects of the disclosure may be appreciated through a discussion of various examples using this context.

Some distributed storage systems strip multiple storage data units (e.g., block(s), file(s), object(s)) of data across storage devices (e.g., disks) to provide higher input/output performance (e.g., by reading/writing to/from multiple storage devices in parallel). Thus, for example, each block of a file may be distributed across multiple disks in a disk array. In order to overcome data file access problems, some distributed storage systems such as IBM Spectrum Scale® (SPECTRUM) (formerly known as GPFS®) have been developed. SPECTRUM systems may achieve scalability through, for example, its shared-disk architecture. This allows all compute nodes in a cluster have equal access to all the disks. Each file is striped in data blocks across some or all of the disks in the system (which may be several thousand disks in the largest systems). Therefore, when a particular I/O (e.g., read) request is issued to a file, each of the data blocks are accessed in parallel to as many storage devices as necessary to achieve the bandwidth of which the switching fabric is capable.

Breaking data into units, such as blocks and reading/writing from multiple storage devices in parallel may result in high reading/writing speeds for a single file. Consequently, this speed as well as the quantity of times the storage device components are utilized in distributed storage systems may cause storage device failure. Disk failure, for example, may include problems with the read/write head (e.g., head crash—a head contacting the platter of a disk), circuit failure, bearing or motor failure (e.g., burn out or wear), bad magnetic sectors, etc. Even if a single disk of multiple disks experiences failure, this may be a serious enough issue such that data may be lost. To prevent this data loss, some distributed storage systems have a backup mechanism that makes multiple copies of each data unit to storage devices that may not be faulty such that a particular I/O operation may succeed. For example, the SPECTRUM file system makes 2 additional copies of data for each data block or set of data blocks of a file, which is known as “replication.” One copy is stored to a local compute node storage device and the other 2 copies are stored or replicated to remote storage devices corresponding to other compute nodes across the network. Accordingly, if the local compute node storage device fails, the one or more of the other storage devices may be queried for the same data.

A particular issue is that distributed storage systems may fail to migrate these storage data units to a destination host or storage device when a virtual instance (e.g., virtual machine) migration occurs to the destination host. When the destination host that has received such virtual instance then issues an I/O request, that destination host may then have to fetch the data over a network back to the original source host, which may increase network latency, decrease access speed, and increase the chances of a data transfer failure.

In an illustrative example, when the OPENSTACK cloud infrastructure is combined with a SPECTRUM storage system environment, during live migration of a virtual machine (VM), the running state (e.g., CPU, memory) will migrate from a source compute node to the target compute node but the source compute node's associated local storage blocks will not be migrated along with the VM migration. A “running state” may refer to changes made by a user of a scaleable application that affect various components. Live migration may include moving VM instances among physical hosts without downtime. A VM live migration allows administrators to perform maintenance or resolve a problem on a host without affecting the end-user experience.

A VM includes at least two components: (1) the VM's storage (virtual hard disk) and (2) the VM's configuration or state (e.g., the specification of the resources allocated to the virtual machine, such as processors, memory, disks, network adapters, user interfaces, etc.). Often, a VM's storage is physically located at one or more storage devices of a separate network (e.g., a Storage Area Network (SAN)), and its configuration is what is located in a host compute node's memory and executed by its local processor. With traditional live migration, the VM's configuration is copied from one physical source compute node to another target compute node. However, the VM's physical storage does not move during or as a part of the live migration process. Therefore, when the target compute node issues an I/O request for the data in the VM storage that was not migrated, the target compute node may have to communicate over a network and be subject the problems described above. Accordingly, some embodiments of the present disclosure address some or all of these problems as described below.

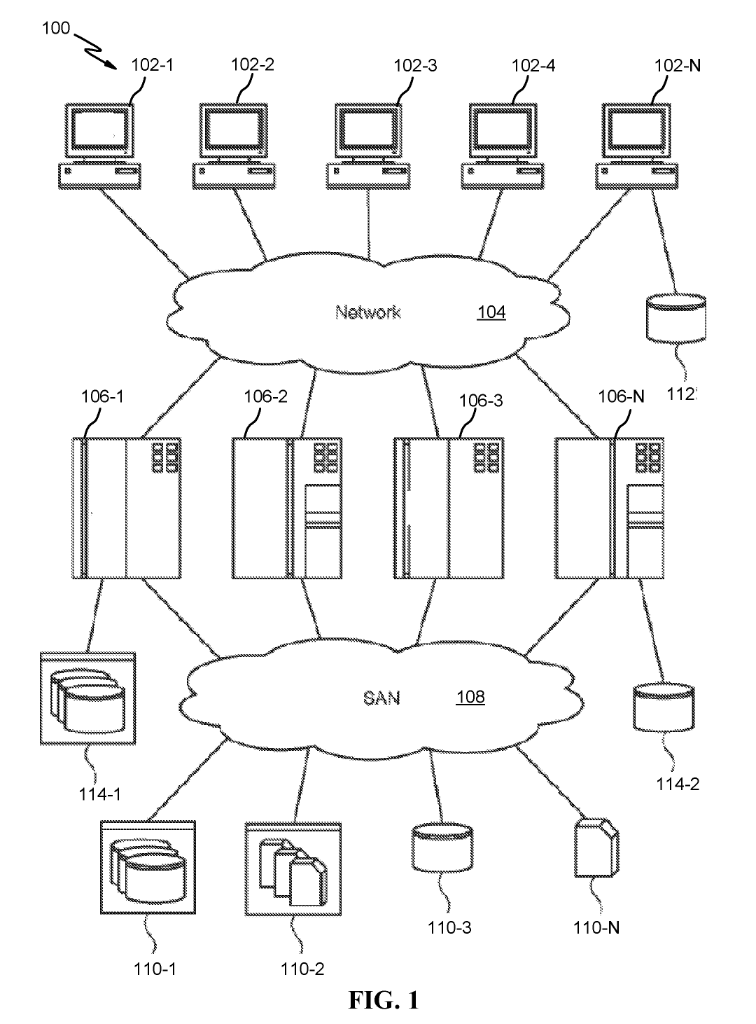

FIG. 1 is a block diagram of an example network architecture 100, according to embodiments. The network architecture 100 is presented to show one example of an environment where a system, method, and/or computer program product in accordance with the disclosure may be implemented. The network architecture 100 is presented only by way of example and is not intended to be limiting. The system and methods disclosed herein may be applicable to a wide variety of different computers, servers, storage devices, and network architectures, in addition to the network architecture 100 shown.

As shown, the network architecture 100 includes one or more computing devices 102 (102-1, 102-2, 102-3, 102-4, 102-N) and 106 (106-1, 106-2, 106-3, 106-N) that are interconnected or communicate via the network 104. The network 104 may be or include, for example, a local-area-network (LAN), a wide-area-network (WAN), the Internet, and/or an intranet, etc. In certain embodiments, the computing devices 102 are client computing devices (e.g., laptops, desktops, and/or mobile devices) and the computing devices 106 are server computing devices. Accordingly, client computing devices 102 may initiate communication sessions, whereas server computing devices 106 (or “host compute nodes”) may wait for requests from the client computing devices 102. In certain embodiments, the computing devices 102 and/or 106 locally include one or more internal or external direct-attached storage systems (e.g., arrays of hard-disk drives, solid-state drives, tape drives, etc.). For example, the computing device 102E includes a local storage device 112. To be “local” as described herein refers to a storage device that is physically and externally attached or housed within a computing device as opposed to a storage device that is queried by a computing device over a network (e.g., the SAN network 108) to access data. The computing devices 106-1 and 106-N also respectively include local storage devices 114-1 and 114-2. These computing devices 102, 106 and direct-attached storage systems 112, 114-1, 114-2 may communicate using protocols such as ATA, SATA, SCSI, SAS, Fibre Channel, or the like.

The network architecture 100, in certain embodiments, includes a storage-area-network 108 (SAN). This network 108 may connect any or all of the computing devices 106 to one or more storage nodes 110, such as arrays 110-1 of hard-disk drives or solid-state drives, tape libraries 110-2, individual hard-disk drives or solid-state drives 110-3, tape drives 110-N, and/or CD-ROM libraries. The storage nodes 110 as described herein may include one or more storage devices. To access a storage node 110, a computing device 106 may communicate over physical connections from one or more ports on the computing device 106 to one or more ports on the storage node 110. A connection may be through a switch, fabric, direct connection, or the like. In certain embodiments, the computing devices 106 and storage nodes 110 may communicate using a networking standard such as Fibre Channel (FC). One or more of the storage nodes 110 may contain storage pools that may benefit from management techniques according to the disclosure. In some embodiments, the storage nodes 110 may be computing devices and include one or more storage controllers or processors, memory devices, and host adapters to control access to each storage device that is within a particular storage node 110.

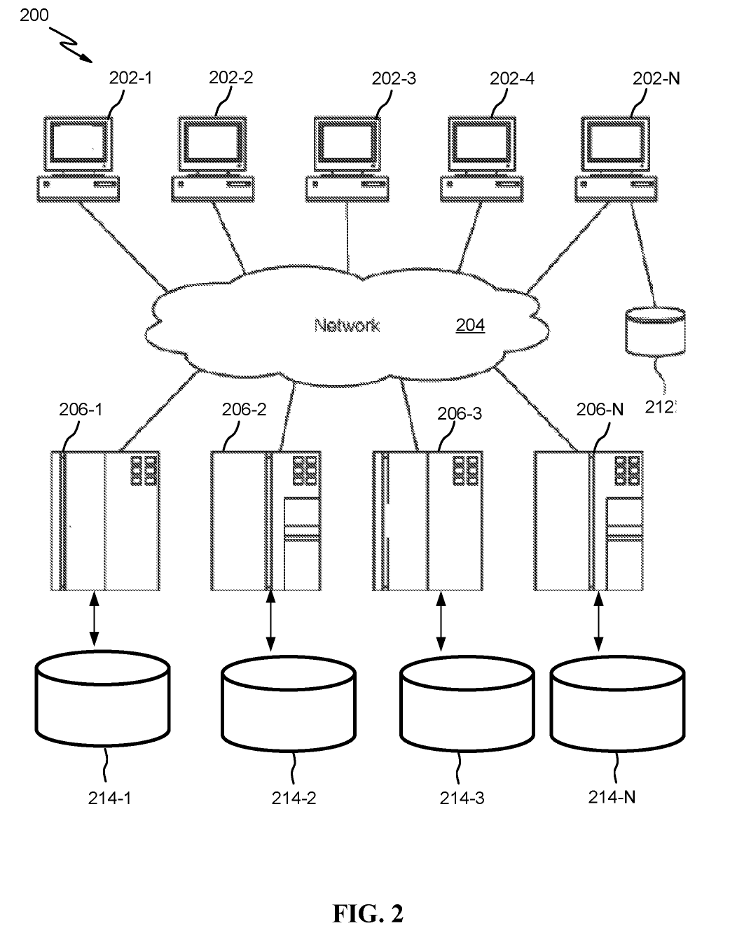

FIG. 2 is a block diagram of an example network architecture 200, according to embodiments. FIG. 2 includes the computing devices 202 (202-1, 202-2, 202-3, 202-4, 202-N), which are communicatively coupled, via the network 204, to the compute nodes 206 (206-1, 206-2, 206-3, 206-N). Each compute node 206 includes local storage devices 214-1, 214-2, 214-3, 214-N. The network 204 may be or include any suitable network, such as a LAN, a WAN, and/or a public network (e.g., the internet).

FIG. 2 illustrates at least that instead of each compute node sharing data over a storage network, such as the SAN network 108 as illustrated in FIG. 1, some or each of the compute nodes 206 may share data that is locally attached to each of the storage nodes 206. For example, the storage device 214 may be a rotating magnetic disk drive physically within the compute node 206-1. Alternatively, the storage device 214 may be a storage device that is externally attached to the compute node 206-1. In some embodiments, the network architecture 200 represents a shared nothing architecture, where cluster compute nodes only have local storage. In some embodiments, the network architecture 200 represents a Network Attached Storage (NAS) system. Thus, some or each of the compute nodes 206 represent NAS servers, and one or more of the storage devices 214 represent NAS storage device(s).

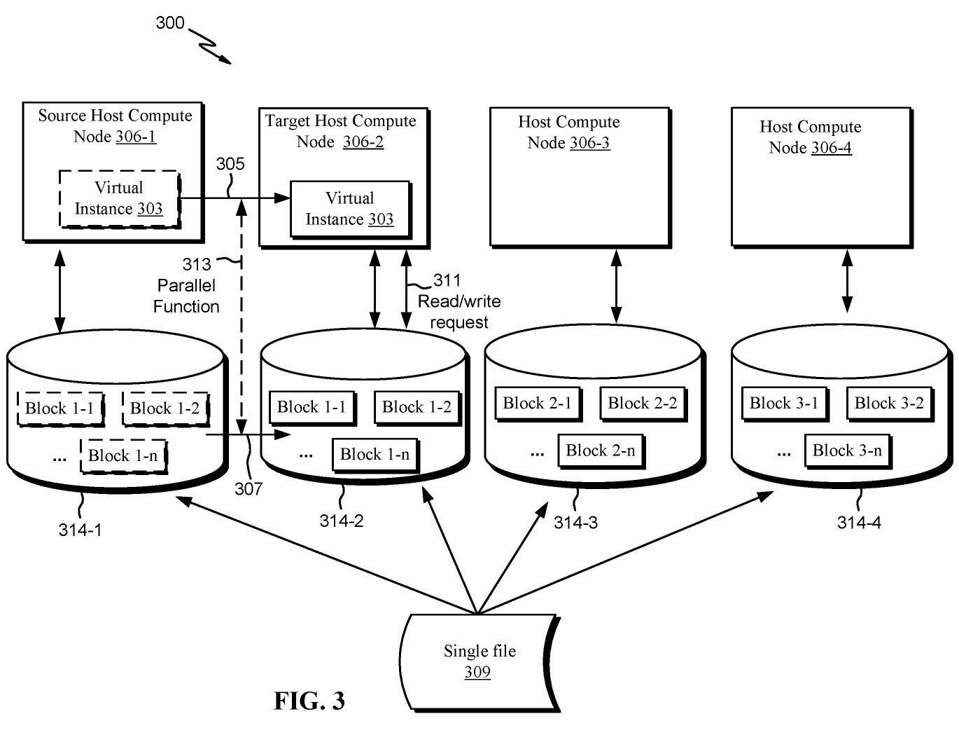

FIG. 3 is a block diagram of an example computing environment 300, according to embodiments. FIG. 3 illustrates that data units from storage devices may be migrated in parallel with virtual instance migrations. The term “virtual instance” as disclosed herein refers to any virtual resource or virtual set of resources that runs on a physical computing device host. For example, a virtual instance may be or include one or more of: a virtual machine, a container, an operating system, virtual memory, a virtual CPU, a virtual hard disk, application, and/or configuration data, etc. These resources may be assigned to corresponding hardware resources and may be managed by a hypervisor. In various cloud environments, such as the OPENSTACK cloud infrastructure, before any virtual instance is migrated, data may be copied or backed up in a distributed storage system to multiple storage devices. For example, referring to FIG. 3, at a first time particular blocks of the file 309 are written or copied to the 3 storage devices 314-1, 314-3, and 314-4 (i.e., blocks 1-1, 1-2, 2-1, 2-2, 3-1, 3-2). The original data blocks (i.e., the data blocks used in I/O operations before a disk failure) may be blocks 1-1, 1-2, and 1-N. In some embodiments, duplicate (e.g., backup) copies of the same blocks may be copied to storage devices 314-2, 314-3, and 314-4. When the source host compute node 306-1 requests to read/write data associated with the virtual instance 303 data, the data located within storage device 314-1 is locally accessible and is often accessed, particularly when data has not been read into memory. However, upon virtual instance migration, systems today may fail to migrate storage device copy data because it can involve multiple complexities. But these complexities may be resolved by various embodiments of the present disclosure as described in more detail below.

After blocks of the file 309 have been written to the storage devices 314-1, 314-3, and 314-4, at a second time the virtual instance 303 may be migrated. The source host compute node 306-1 may receive a request to migrate its virtual instance 303 to the target local host compute node 306-2. During or at substantially the same time as the migration 305 of the virtual instance 303 from the source host compute node 306-1 to the target local host compute node 306-2, the storage device's 314 block data may be migrated 307 to the storage device 314-2 as illustrated by the parallel function 313. Therefore, for example, the same data located in both the virtual instance (e.g., the memory) and the storage device 314-1 is migrated to the same storage subsystem such that data may always be accessed locally regardless of whether or not data has been read into memory from a storage device.

At a third time, after instance and data block migration, the target local host compute node 306-2 may receive a read/write request for the block data located in the storage device 314-2. Because these block data have been migrated, the target local host compute node 306-2 may locally access the data, as opposed to fetching the data over the network back to storage device 314-1. This may have several advantages, such as reducing network traffic, speeding up data access, offer more efficiency and stable environment to users, and reducing data transfer failure. In some embodiments, each of the data blocks represent 3 identical copies of the same blocks. In other embodiments, each of the blocks represent different strips of blocks of the same single copy file 309. In some embodiments, the data located in each of the storage devices 314 are stored/retrieved in other ways as opposed to a block system. For example, the data may be organized as “objects.” Objects may include file data bundled with user-defined metadata (unlike blocks that have limited or no metadata). Any data that is located in a storage device may be referred to herein as “storage units.” It is to be understood that although FIG. 3 illustrates 4 compute nodes and storage devices (e.g., 306-1, 306-2, 306-3, and 306-4), there may be more or fewer of these components.

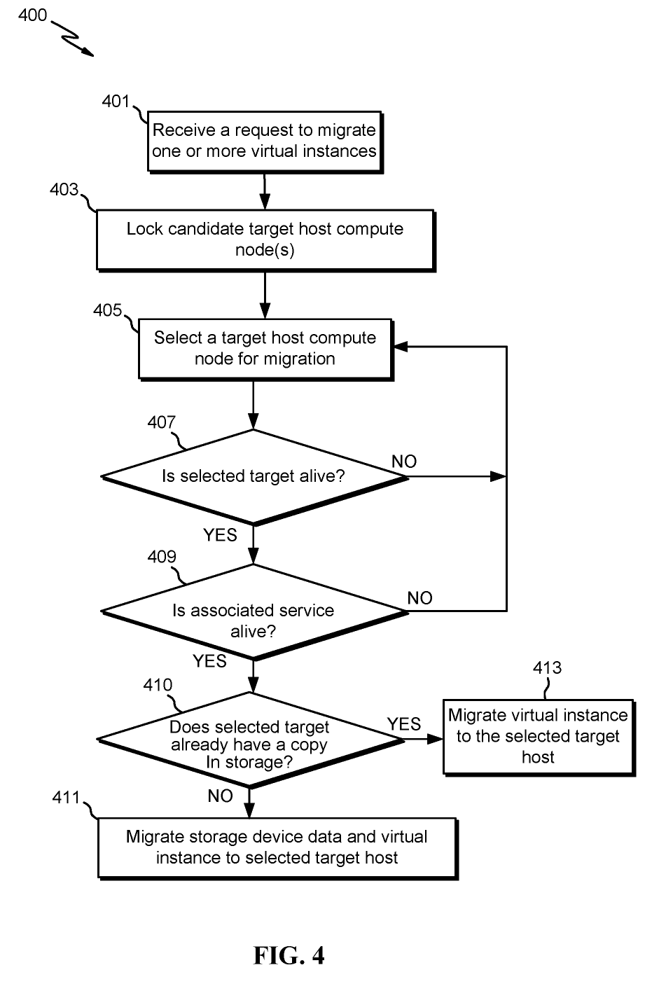

FIG. 4 is a flow diagram of an example process 400 of selecting a target host compute node for storage data unit migration, according to embodiments. At block 401 a request may be received (e.g., by a source host compute node 206-1) to migrate one or more virtual instances (e.g., because a particular host needs repair). Per block 403, one or more candidate target (i.e., destination) host compute nodes are locked (e.g., by a lock manager of a compute node). The one or more candidate target host compute nodes are candidates to receive migration data. In some embodiments, the locking at block 403 includes “distributed locking.” Distributed locking occurs when every file system operation acquires an appropriate read or write lock to synchronize with conflicting operations on other host compute nodes before reading or updating any file system data or metadata.

Some distributed storage systems use a centralized global lock manager running on one of the nodes in a cluster, in conjunction with local lock managers in each host compute node. The global lock manager coordinates locks between local lock managers by handing out lock tokens, which convey the right to grant distributed locks without the need for a separate message exchange each time a lock is acquired or released. Repeated accesses to the same disk object from the same host compute node may only require a single message to obtain the right to acquire a lock on the object (the lock token). Once a compute node has obtained the token from the global lock manager (also referred as the token manager or token server), subsequent operations issued on the same compute node can acquire a lock on the same object without requiring additional messages. Only when an operation on another node requires a conflicting lock on the same object are additional messages necessary to revoke the lock token from the first node so it can be granted to the other node.

Certain applications write/read to the same file to/from multiple compute nodes. Some distributed storage systems use byte-range locking to synchronize reads and writes to file data. This approach allows parallel applications to write concurrently to different parts of the same file, while maintaining POSIX read/write atomicity semantics. Byte-range tokens are negotiated as follows. The first compute node to write to a file will acquire a byte-range token for the whole file (zero to infinity). As long as no other compute nodes access the same file, all read and write operations are processed locally without further interactions between compute nodes. When a second compute node begins writing to the same file it will need to revoke at least part of the byte-range token held by the first node. When the first node receives the revoke request, it checks whether the file is still in use. If the file has since been closed, the first node will give up the whole token, and the second node will then be able to acquire a token covering the whole file. Thus, in the absence of concurrent write sharing, byte-range locking in GPFS behaves just like whole-file locking and is just as efficient, because a single token exchange is sufficient to access the whole file.

Per block 405, a host compute node may then be selected as the host to migrate data to. The selection may occur by determining (e.g., by a monitoring agent module within a host compute node) whether one or more host compute nodes meet one or more policies or rules. The one or more host compute nodes may each be included in a pool as target candidates for migration. In some embodiments, the selection includes checking each of the host compute node indexes and if some or all indexes are under/over a threshold, that host compute node may then be selected for migration. For example, index factors may be or include: CPU usage, memory usage, and/or storage device usage of a particular compute node. In an example illustration, static calculations may be performed to determine if a particular host compute node meets policy criteria, such as determining whether the CPU has less than 80% usage (e.g., the amount of time a CPU was used for processing instruction(s)), whether the memory usage is less than 80% (e.g., the amount of RAM a program(s) uses), and whether the storage device usage is less than 80%. In some embodiments, if and only if each of these (or analogous) criteria will be met, will a host compute node be selected for data migration.

In some embodiments, factors are dynamically calculated, such as weighting indexes. That is, each index may take on more priority or be ranked higher compared to other indexes for node selection. For example, disk usage (as opposed to CPU or memory) may be the most important factor for data block migration, and accordingly may be weighted higher for node selection. In an illustrative example of this, if a non-weighted index met a threshold value, that may be incremented by a first simple integer value for scoring purposes. Conversely, if a weighted index met a threshold value, that weighted index may be incremented by the same first simple integer value and the first value may also be multiplied by some second integer value x such that the final score is higher for the weighted factor. In another example illustration of dynamic calculations, if it is determined that more than one host compute nodes meet policy criteria, one single host compute node that is ranked the highest may be selected. For example, even though several host compute nodes meet threshold criteria, the host compute node with the highest score (e.g., the sum of all integer values) may be selected.

Per block 407, it may be determined (e.g., by the source host compute node) whether the selected host compute node is alive. Being “alive” may correspond to whether a communication session can be established in order to ensure that migration occurs successfully. For example, a command (e.g., a “network ping” command) may be transmitted to the selected host compute node to determine whether an address on the selected node is reachable and responsive. If the selected host is not alive, then another host compute node will be selected at block 405.

Per block 409, if the selected host compute node is alive, then it may be determined whether the selected host compute node's service is alive or currently running. A service is used for hosting and managing network systems (e.g., cloud computing systems), such as clusters of host compute nodes. For example, the service may include a Nova engine, which is the OPENSTACK compute service. Nova is built on a messaging architecture and all of its components can typically be run on several host compute nodes. This architecture allows the components to communicate through a message queue. A command can be used (e.g., a “service” command for services running on Linux) in order to check the status of the service. If the associated service is not alive, then another host compute node will be selected at block 405.

OPENSTACK is an Infrastructure as a Service (IAAS), which includes various components: Nova, Swift, Cinder, Neutron, Horizon, Keystone, Glance, Ceilometer, and Heat. Nova is the primary computing engine behind OPENSTACK that is used for deploying and managing large numbers of VMs/virtual instances to handle computing tasks (e.g., handle any of the virtual instance migration operations as specified in FIGS. 3-7). Swift is a storage system for objects and files. Rather than the traditional idea of referring to files by their location on a disk drive, developers can instead refer to a unique identifier referring to the file or piece of information and let OPENSTACK decide where to store this information. Cinder is a block storage component, which allows access to specific locations on a disk drive (e.g., the block data units specified in FIGS. 3-7). Neutron provides networking capability for OPENSTACK by ensuring that each component can communicate with another quickly and/or efficiently. Horizon is the graphical user interface (GUI) to OPENSTACK. Keystone provides identity services for OPENSTACK, such as providing a list of all of the users in the OPENSTACK cloud, mapped against all of the services provided by the cloud, which they have permission to use. Glance provides allows images or virtual copies of hard disks to be used as templates when deploying new virtual instances. Ceilometer provides telemetry services that allow the cloud to provide billing services to individual users of the cloud. Heat allows developers to store requirements of a cloud application in a file that defines what resources are necessary for that application. One or more of these components may perform one or more operations as described in the present disclosure (e.g., the operations described in FIG. 3).

Per block 410, if the selected host compute node's service is alive, it may be determined (e.g., by a file manager node) whether the selected host compute node already has a copy or replicated version of the data associated with the virtual instance in its storage device (e.g., local storage device). For example, as explained above, in a SPECTRUM environment on OPENSTACK, 3 copies of data are made to 3 different disks associated with 3 different compute nodes. There may be no selection criteria for these target nodes to receive the copies and therefore they may be selected randomly. Accordingly, the selected host compute node may be checked to see if its storage device(s) already contains 1 of the 3 copies of data.

Per block 413, if the selected target host already has a copy in its storage device, then the virtual instance may be migrated from the source host to the selected target host. The storage device data is not migrated because it is already within the selected target host's storage device. Per block 411, if the selected target host compute node does not already have a copy in its storage device, then both the storage device data and the virtual instance may be migrated from the source host compute node to the selected target host compute node.

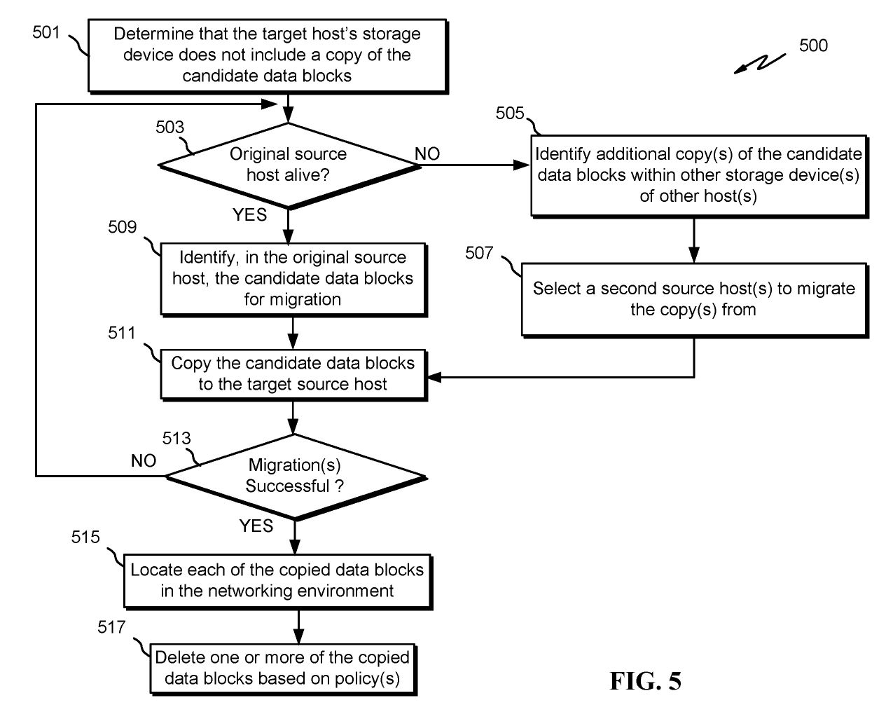

FIG. 5 is a flow diagram of an example process 500 for data block migration between storage devices, according to embodiments. In some embodiments, the process 500 is a sub-process for the migration logic as identified at blocks 411 and/or 413 in the process 400 of FIG. 4. In some embodiments, data units other than “blocks” may be migrated (e.g., objects). The process 500 may begin at block 501 when it is determined (e.g., by a distributed file system manager) that the target host's storage device does not include a copy of the candidate data blocks. For example, referring back to FIG. 4, block 501 may correspond to a “NO” determination according to block 410, with block 411 following.

Per block 503, it may be determined whether the original source host is alive. If the original source host is not alive (e.g., a communication session cannot be established between a distributed storage system manager compute node and the original source such that migration cannot occur), then per block 505, one or more additional copies of the candidate data blocks may be identified within one or more other storage devices of one or more other compute nodes. For example, when data associated with a virtual instance is backed up, each block of data within a corresponding storage device may be copied or replicated to a local compute node disk and multiple remote compute node disks (i.e., there may be various copies of the data located at multiple disks in the network in case of a disk failure). The “local” compute node may be the original source host but it may not be alive. Accordingly, because data cannot be copied from the local compute node, other compute nodes in the network environment may have to be queried to complete the source migration operation. In some embodiments, in order to identify at block 505, the distributed storage system manager includes a data object that specifies an ID of each compute node and which of the compute nodes includes a copy of the candidate data blocks within a corresponding storage device.

Per block 507, a second set of one or more source hosts (or storage devices) may be selected (e.g., by the distributed storage system manager) as a source to migrate the one or more additional copies from. The selection at block 507 may be based on one or more policies. For example, one or more indexes may be identified and scored for selection. For example, network indexes, such as bandwidth may be identified, as well as Disk I/O, CPU usage, memory usage, etc. In an illustrative example, a particular compute node may be selected if its bandwidth is greater than or equal to 10 Mbit/s, its disk I/O and CPU usage is lower than 30%, and/or its memory usage is less than or equal to 50%. After selection based on these policies, per block 511, the additional copies of the candidate data blocks may be copied from the selected set of compute node host's storage device(s) to the target source host's storage device(s).

Per block 509, if the original source host is alive, then the candidate data blocks may be identified in the original source host as candidates for migration. Per block 511, the candidate data blocks located in the local storage device(s) of the original source host is copied to the target source host. Per block 513 it may be determined (e.g., by a file system manager) whether the migration was successful. A migration may fail or not be successful for various reasons. For example, a communication may not be able to be established between compute nodes within a particular time frame, a critical system service may not be running (e.g., a virtual machine manager), a firewall may be preventing the migration, etc. The determination at block 513 may occur via one or more methods. For example sample testing, such as iterative test, debug and retest method, where subsequent executions of the testing process reveal different error conditions as new samples are reviewed. Post-testing methods may include testing the throughput of the migration process (i.e., the number of records per unit time), comparing migrated records to records generated by the target system, and/or summary verifications that provide summary information including record counts and checksums.

If the one or more migration actions are not successful then, for the migration(s) that are not successful, a loop may be initiated such that actions in block 503 (and other actions below it) may be performed again. In some embodiments, if the migration is unsuccessful, a copy of the corresponding candidate data block(s) may be identified on a storage device of another host compute node and a migration session may be initiated from the new host compute node to the target node in order to try to make migration successful. Per block 515, if the one or more migration operations are successful, then each of the copied data blocks in the networking environment may be located or identified. Per block 517, one or more of the copied data blocks may then be deleted based on one or more policies. For example, a policy may include a directive to delete one or more blocks that are associated with poor performance indexes. In an illustrative example, an index may be a quantity of disk storage available, and if there is not a threshold quantity of storage space available, the block may be deleted.

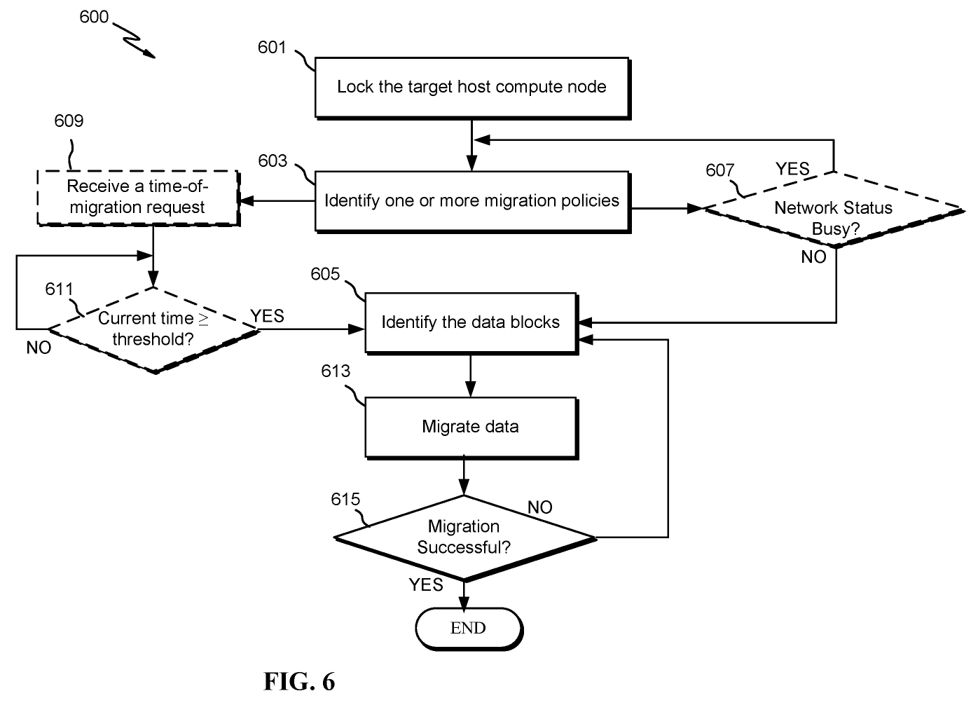

FIG. 6 is a flow diagram of an example process 600 for data migration, according to embodiments. The process 600 may begin at block 601 when target host compute node has been locked (e.g., via the methods described at block 403 of FIG. 4) and selected. Per block 603, one or more migration policies may be identified. In some embodiments, these migration policies are instructions stored in memory/storage device and are executed via an automated background task. In some embodiments, the migration policies are user-defined policies. For example, in some embodiments, migration policies may be based on whether the network is busy. Accordingly, per block 607, it is determined whether the network status is busy or fails to meet some other network criteria. This determination may be based on one or more factors, such as whether the network latency (i.e., the time it takes for data to get from one host to another) is above/below a threshold, whether the available bandwidth is above/below a threshold, and/or whether there is an outage. If the network is busy, then the target node may continue to be polled until the network is free. Accordingly, a looping function may be performed until the network is not busy. If the network is not busy, then at block 605 the data blocks that are candidates for migration may be identified in the source host compute node.

In some embodiments, instead of or in addition to the network policies as described at block 607, time-based policies may be set for migration. For example, a user may specify and a host compute node may receive, at block 609, a time-of-migration request. Accordingly, the user may specify a particular time (e.g., a clock time, countdown time, etc.) when the migration should be initiated. Per block 611, it may be determined (e.g., by counter logic in a compute node) whether the current time is greater or equal than a threshold. If the current time is not greater than or equal to a threshold then the counter may be polled in a looping fashion until the threshold has been met or exceeded. If the current time has met or exceeded a threshold, then the data blocks may be identified at block 605. In an illustrative example, the user may have set the time of migration to occur in 5 minutes at block 609. Accordingly, a counter may be polled (e.g., every minute) until the 5 minute mark (the threshold value) has arrived, at which point the process 600 may continue at block 605.

Per block 613, the data blocks (and the corresponding virtual instance) may be migrated from the source host compute node to the target host compute node. Per block 615, it may be determined whether the migration was successful. If the migration was not successful, then block 605 may be performed again to restart the migration process until the migration is successful. If the migration is successful, the process 600 may stop.

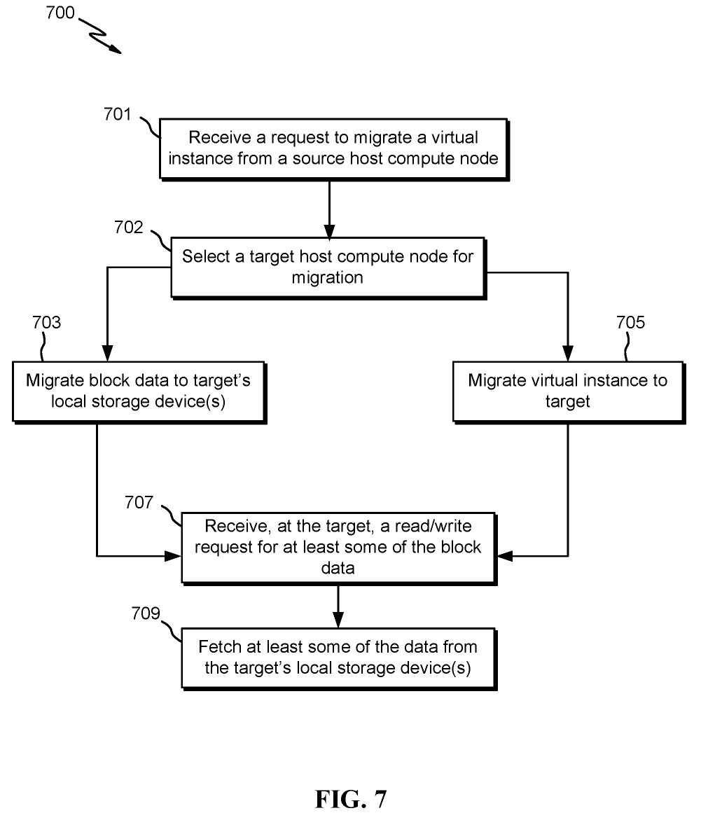

FIG. 7 is a flow diagram of an example process 700 for migrating block data in parallel with virtual instance data, according to embodiments. At block 701 a request may be received (e.g., at a distributed file system manager node) to migrate a virtual instance from a source host compute node. For example, the source host compute node need physical repair. An administrator may consequently issue a request to migrate a virtual instance in order to repair the source host compute node.

Per block 702, a target host compute may then be selected (e.g., by a monitoring agent) for migration. In some embodiments, the method of selection may be or include any method as described in block 405 of FIG. 4 or block 507 of FIG. 5. The target host compute node may have access (e.g., via a network or local access to) to a first storage device. The first storage device may also include one or more data blocks (or units) associated with the virtual instance. For example, referring back to FIG. 1, the target host compute node may be the computing device 106D, which may have access either to its local storage device 114B or any of the storage devices 110 via the SAN network. The first storage device may include data blocks (or units) of data that match or are copies of data that is located in the virtual instance. For example, the data blocks may be portions of a file that are stored to a storage device. The exact portions of the same file may also be located within the virtual instance. For example, the virtual instance may be a VM that includes a virtual disk file(s). The virtual disk files(s) may store all of the contents that are in the VM's physical disk drive.

Per block 703, the block data may be migrated to the target host compute node's local storage device (or any storage device the target has access to). In some embodiments, the migration at block 703 may be or include functions as described in blocks 411 of FIG. 4, block 511 of FIG. 5, and block 613 of FIG. 6. Per block 705, the virtual instance may be migrated to the targets host compute node. In some embodiments, the migration at block 705 may be or include the functions described at blocks 413, 411 of FIG. 4, and blocks 613 of FIG. 6. The migrations at blocks 703 and 705 may occur in parallel (e.g., at substantially the same time, as part of the same request at block 701, processed as a single program instruction of a single transaction, simultaneous operations, etc.).

Per block 707, the target host computing device may receive a read/write (or delete) request corresponding to at least some of the block data (e.g., the read/write request 311 of FIG. 3). It may be determined that at least some of the block data is stored locally to the target host computing device. Per block 709, based on the determining, at least some of the data may be fetched from the target host compute node's local storage device(s). In an illustrative example, in a distributed storage system, a first data file may be parsed into multiple blocks and the blocks may be striped to a plurality of storage devices of multiple compute nodes. A client computing device (e.g., the computing device 102-1 of FIG. 1) may issue a “read” request for the first file. The block data that is part of the migration at block 703 may be included in the first file and be located in the target host compute node's storage device. Accordingly, when the target host compute node receives the client's request, the target host compute node may fetch, without communicating over a network, the migrated data blocks (or units) from the local storage device. However, in order to return the entire file, a second set of blocks may have to be fetched, over the network, from the plurality of storage device. The fetching for the second set of data blocks may occur in parallel with the fetching of the data blocks that are part of the migration at block 703.

Fetching some or all of the data units locally may improve performance. Typically, when data is requested within distributed storage systems, the request is routed to the host that includes a virtual instance of the data without regard to where the data is physically located on a storage device. Consequently, for example, a request may be routed to a host compute node that includes the virtual machine of the data needed. However, if data is not located in the memory or virtual machine yet, the data may have to be fetched over a network and within a storage device that is not connected to the host compute node that the request was routed to. Therefore, particular transactions or data requests may experience network latency or other access problems by having to fetch data that is remote to the selected host. Accordingly, embodiments of the present disclosure enable each request to access at least some of the data locally by migrating data blocks when a virtual instance migration occurs, as described above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

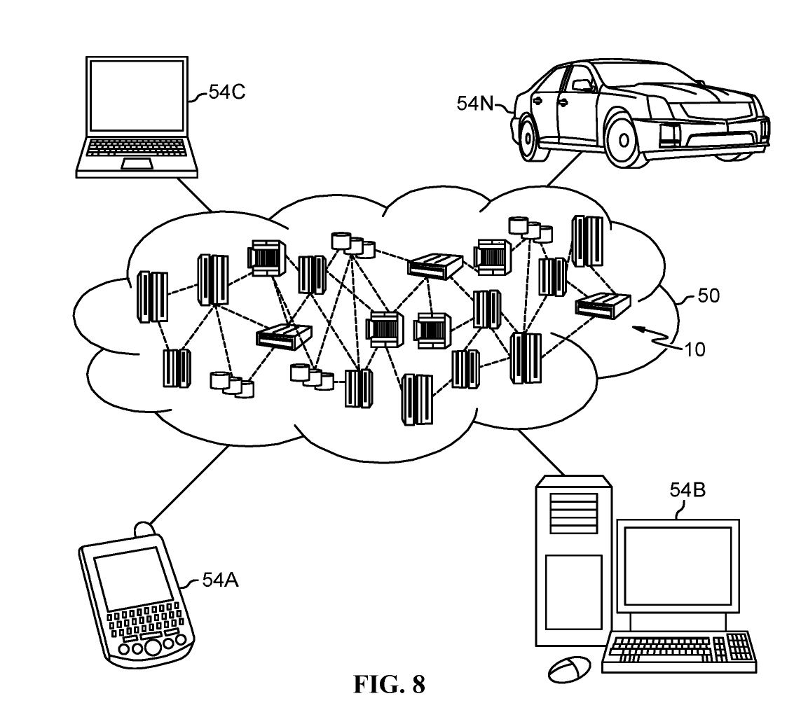

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

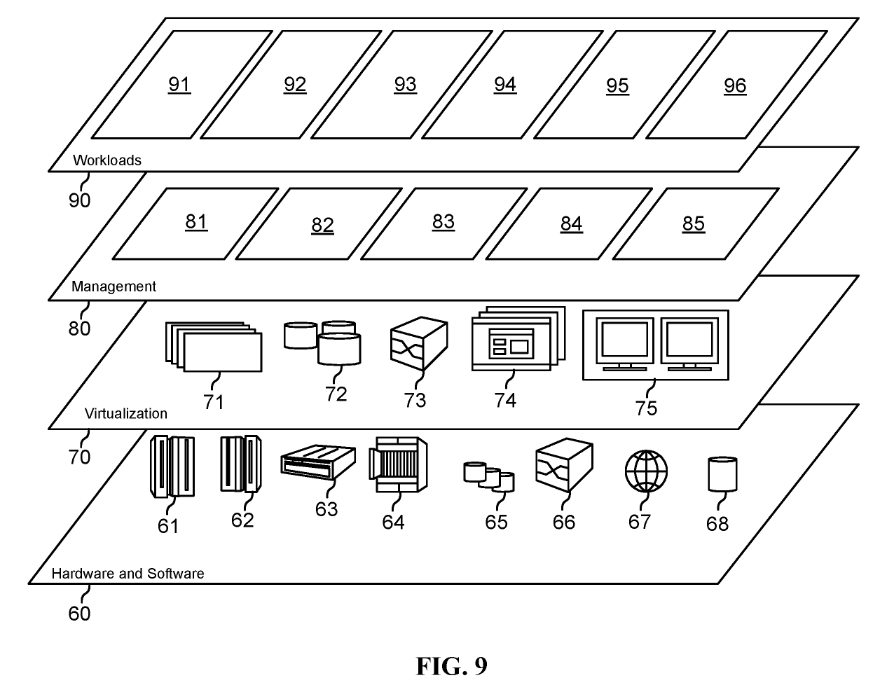

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and storage migration 96 (e.g., one or more processes as specified in FIG. 3-7).

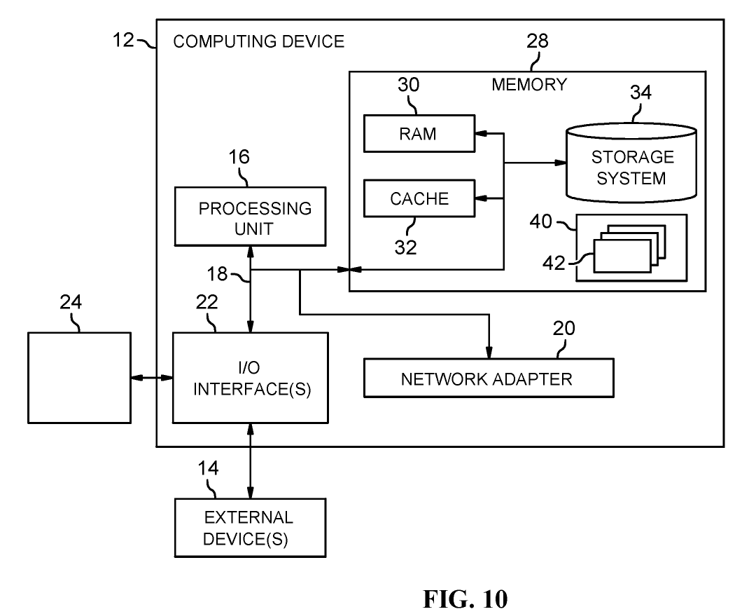

FIG. 10 is a block diagram of a computing device 12, according to embodiments. As shown in FIG. 10, the computing device 12 is shown in the form of a general-purpose computing device, which is not to be construed necessarily by one of ordinary skill in the art as a generic computer that performs generic functions. Rather, the computing device 12 is illustrative only of what components a computing device may include. The components of computing device 12 may include, but are not limited to, one or more processors or processing units 16, a system memory 28, and a bus 18 that couples various system components including system memory 28 to processor 16. In some embodiments, the computing device 12 represents the computing devices 102/202 of FIGS. 1 and 2, the host compute nodes 106-1/206-1 of FIGS. 1 and 2, the storage nodes 110 of FIG. 1, the compute nodes 306 of FIG. 3, and/or the cloud computing nodes 10 of FIG. 8.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 12 typically includes a variety of computer system readable media. Such media may be any available media that is accessible by computing device 12, and it includes both volatile and non-volatile media, removable and non-removable media.

System memory 28 can include computer system readable media in the form of volatile memory, such as random access memory (RAM) 30 and/or cache memory 32.

Computing device 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein. For example, the program modules 42 may be or include components as described herein such as the lock manager, distributed storage system manager, any of the OPENSTACK components, a hypervisor and/or perform any portion of the processes 400. 500, 600, and/or 700.

Computing device 12 may also communicate with one or more external devices 14 such as a keyboard, a pointing device, a display 24, etc.; one or more devices that enable a user to interact with computing device 12; and/or any devices (e.g., network card, modem, etc.) that enable computing device 12 to communicate with one or more other computing devices. Such communication can occur via Input/Output (I/O) interfaces 22. Still yet, computing device 12 can communicate with one or more networks such as a local area network (LAN), a general wide area network (WAN), and/or a public network (e.g., the Internet) via network adapter 20. As depicted, network adapter 20 communicates with the other components of computing device 12 via bus 18. It should be understood that although not shown, other hardware and/or software components could be used in conjunction with computing device 12. Examples, include, but are not limited to: microcode, device drivers, redundant processing units, external disk drive arrays, RAID systems, tape drives, and data archival storage systems, etc.

Aspects of the present invention may be a system, a method, and/or a computer program product. The computer program product may include a computer readable storage medium (or media) having computer readable program instructions thereon for causing a processor to carry out aspects of the various embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a request to migrate a virtual instance from a source host compute node, the source host compute node being included in a distributed storage system environment;
selecting a target host compute node to migrate the virtual instance to, the target host compute node having access to a first storage device, the first storage device includes one or more data units associated with the virtual instance;
migrating the virtual instance from the source host compute node to the target host compute node; and
migrating, in parallel with the migrating of the virtual instance, the one or more data units to a second storage device associated with the target host compute node;

2. The method of claim 1, wherein the one or more data units are replicated to a third storage device, the method further comprising determining, prior to the migrating of the one or more data units, that the target host compute node does not include a replicated copy of the one or more data units, and wherein the migrating of the one or more data units occurs in response to the determining that the target host compute node does not include the replicated copy.

3. The method of claim 1, wherein the one or more data units are replicated to a third storage device and a fourth storage device, the third storage device being local to a third host compute node, the fourth storage device being local to a fourth host compute node, the method further comprising:
determining that the source host compute node is not alive, wherein the one or more data units cannot be migrated from the source host compute node to the target host compute node;
identifying the one or more data units that are replicated to the third storage device and the fourth storage device;
selecting, based on one or more policies, the fourth host compute node as a source for migration, wherein the migrating the one or more data units includes migrating the one or more data units from the fourth storage device of the fourth host compute node to the second storage device of the target host compute node.

4. The method of claim 1, wherein the target host compute node is selected among a pool of candidate target host compute nodes for migration destination based on the target host compute node meeting one or more index factors, the one or more index factors being selected from a group consisting of: CPU usage, memory usage, and storage device usage.

5. The method of claim 1, wherein the migrating of the virtual instance and the one or more data units are based on one or more migration policies, the migration policies including migrating the virtual instance and the one or more data units when a network latency is below a threshold.

6. The method of claim 1, further comprising:
receiving, at the target host compute node, a request for a first file, the one or more data units being included in the file; and
fetching, without communicating over a network, the one or more data units from the second storage device.

7. The method of claim 6, wherein the one or more data units are a first set of data blocks of the first file, the method further comprising fetching a second set of data blocks of the first file from a plurality of storage devices over the network in parallel with the fetching of the one or more data units from the second storage device, the plurality of storage devices not including the second storage device.

8. A system comprising:
a computing device having a processor; and
a computer readable storage medium having program instructions embodied therewith, the program instructions executable by the processor to cause the system to perform a method, the method comprising:
migrating a virtual instance from a source host compute node to a target host compute node, the source host compute node including a first storage device with one or more data units;
migrating, simultaneously with the migrating of the virtual instance, the one or more data units to a second storage device included in the target host compute node;
receiving, at the target host compute node and subsequent to the migrating of the virtual instance and the migrating of the one or more data units, a request for a first file that includes the one or more data units;
determining that the one or more data units are stored locally to the target host compute node; and
fetching, based on the determining and without communicating over a network, the one or more data units from the second storage device.

9. The system of claim 8, wherein the one or more data units are replicated to a third storage device, the method further comprising determining, prior to the migrating of the one or more data units, that the target host compute node does not include a replicated copy of the one or more data units, and wherein the migrating of the one or more data units occurs in response to the determining that the target host compute node does not include the replicated copy.

10. The system of claim 8, wherein the one or more data units are replicated to a third storage device and a fourth storage device, the third storage device being local to a third host compute node, the fourth storage device being local to a fourth host compute node, the method further comprising:
determining that the source host compute node is not alive, wherein the one or more data units cannot be migrated from the source host compute node to the target host compute node;
identifying the one or more data units that are replicated to the third storage device and the fourth storage device;
selecting, based on one or more policies, the fourth host compute node as a source for migration, wherein the migrating the one or more data units includes migrating the one or more data units from the fourth storage device of the fourth host compute node to the second storage device of the target host compute node.

11. The system of claim 8, wherein the target host compute node is selected among a pool of candidate target host compute nodes for migration destination based on the target host compute node meeting a plurality of index factor criteria, the plurality of index factors including: CPU usage, memory usage, and storage device usage.

12. The system of claim 8, wherein the migrating of the virtual instance and the one or more data units are based on one or more migration policies, the migration policies including migrating the virtual instance and the one or more data units according to a time set by a user, wherein a counter is polled until the time set by the user has been met.

13. The system of claim 8, wherein the one or more data units are a first set of data blocks, the method further comprising fetching a second set of data blocks of the first file from a plurality of storage devices over the network in parallel with the fetching of the one or more data units from the second storage device, the plurality of storage devices not including the second storage device.

14. The system of claim 8, wherein the system includes a plurality of compute nodes, a first compute node including a global lock manager, a second set of compute nodes of the plurality of compute nodes each including a local lock manager, the method further comprising:
receiving, prior to the migrating of the virtual instance and the one or more data units, a request to migrate the virtual instance;
locking, in response to the receiving of the request, a plurality of candidate target host compute nodes of the plurality of compute nodes, the target host compute node being included within the plurality of candidate target host computing nodes, the locking including coordinating, by the global lock manager, locks between each of the local lock managers; and
selecting, subsequent to the locking and prior to the migrating the virtual instance and the one or more data units, the target host compute node for migration.

15. A computer program product comprising a computer readable storage medium having program code embodied therewith, the program code executable by a computing device to perform a method, the method comprising:
receiving a request to migrate a virtual instance from a source host compute node, the source host compute node being included in a distributed storage system environment;
migrating the virtual instance from the source host compute node to a first target host compute node, the first target host compute node having access to a first storage device, the first storage device includes one or more data units associated with the virtual instance; and
migrating, as part of the request to migrate the virtual instance, the one or more data units to a second storage device associated with the first target host compute node.

16. The computer program product of claim 15, wherein the one or more data units are replicated to a third storage device, the method further comprising determining, prior to the migrating of the one or more data units, that a second target host compute node includes a replicated copy of the one or more data units, and wherein the migrating of the one or more data units occurs in response to the determining that the second target host compute node already includes the replicated copy, and wherein the first target host compute node is selected for migration instead of the second target host compute node in response to the determining that the second target host compute node already includes the replicated copy.

17. The computer program product of claim 15, wherein the one or more data units are replicated to a third storage device and a fourth storage device, the third storage device being local to a third host compute node, the fourth storage device being local to a fourth host compute node, the method further comprising:
determining that the source host compute node is not alive, wherein the one or more data units cannot be migrated from the source host compute node to the first target host compute node;
identifying the one or more data units that are replicated to the third storage device and the fourth storage device;
selecting, based on one or more policies, the fourth host compute node as a source for migration, wherein the migrating the one or more data units includes migrating the one or more data units from the fourth storage device of the fourth host compute node to the second storage device of the first target host compute node.

18. The computer program product of claim 15, wherein the first target host compute node is selected among a pool of candidate target host compute nodes for migration destination based on the first target host compute node meeting one or more index factors, the one or more index factors being selected from a group consisting of: CPU usage, memory usage, and storage device usage.

19. The computer program product of claim 15, the method further comprising:
receiving, at the first target host compute node and subsequent to the migrating of the virtual instance and the one or more data units as part of the request, a second request for a first file, the one or more data units being included in the file; and
fetching, without communicating over a network, the one or more data units from the second storage device.

20. The computer program product of claim 19, wherein the one or more data units are a first set of data blocks, the method further comprising fetching a second set of data blocks of the first file from a plurality of storage devices over the network in parallel with the fetching of the one or more data units from the second storage device, the plurality of storage devices not including the second storage device.
